(19) United States
(12) Patent Application Publication
(10) Pub. No.: US 2016/0102482 A1
(43) Pub. Date: Apr. 14, 2016

(54) AUXILIARY DOOR LOCKING MECHANISM FOR A TRAILER

(71) Applicant: Wabash National, L.P., Lafayette, IN (US)

(72) Inventor: Rodney P. Ehrlich, Monticello, IN (US)

(21) Appl. No.: 14/877,200

(22) Filed: Oct. 7, 2015

Related U.S. Application Data
(60) Provisional application No. 62/061,419, filed on Oct. 8, 2014.

(51) Int. Cl. E05B 67/06; B65D 88/12; E05B 67/00; E05C 7/04; E05C 19/00

(52) U.S. Cl. CPC E05B 67/06; E05C 7/04; E05C 19/003; E05B 67/003; B65D 88/12

(57) ABSTRACT

A locking mechanism for a door of a storage container includes a bearing plate configured to be coupled to the door. The bearing plate includes (i) a body defining a longitudinally-extending channel and (ii) a first pair of horizontally-aligned apertures formed through the body. The locking mechanism also includes a lockrod configured to be received within the channel of the bearing plate for rotational movement relative to the bearing plate. The lockrod includes a second pair of horizontally-aligned apertures formed therethrough. The locking mechanism also includes a fastener configured to be received through the first and second pairs of apertures in order to prevent rotational movement of the lockrod relative to the bearing plate.

This application claims priority under 35 U.S.C. §119(e) to U.S. Provisional Patent Application Ser. No. 62/061,419 entitled AUXILIARY DOOR LOCKING SYSTEM FOR A TRAILER and filed Oct. 8, 2014, the entirety of which is hereby incorporated by reference herein.

### FIELD OF THE INVENTION

The present invention relates generally to storage containers such as semi-trailers, van-type trailers, mobile or stationary storage containers, having one or more access doors, for example. In particular, the present invention relates to auxiliary locking assemblies for maintaining such one or more doors in a closed and secured position.

### BACKGROUND OF THE INVENTION

Door locking assemblies for storage containers, and specifically for mobile storage containers, are known. It is desirable to provide an auxiliary locking system to allow the user an additional means for locking the doors of the trailer or other storage container. In some instances, a user may unlock the locking mechanism of a storage container, and due to the shifting of cargo within the storage container, cargo pressing against the doors of the storage container may cause the doors to unintentionally open prior to the user moving the door locking mechanism to an opened position. In other words, due to shifting cargo, the doors of a storage container may unintentionally open upon unlocking, but not opening, the door locking mechanism. This may damage cargo and injure the user. An auxiliary door locking system may operate to prevent the doors from unintentionally opening upon unlocking the door locking mechanism.

### SUMMARY

The present invention may comprise one or more of the features recited in the attached claims, and/or one or more of the following features and combinations thereof.

According to one aspect of the present disclosure, a locking mechanism for a door of a storage container includes a bearing plate configured to be coupled to the door. The bearing plate includes (i) a body defining a longitudinally-extending channel and (ii) a first pair of horizontally-aligned apertures formed through the body. The locking mechanism also includes a lockrod configured to be received within the channel of the bearing plate for rotational movement relative to the bearing plate. The lockrod includes a second pair of horizontally-aligned apertures formed therethrough. A fastener of the locking mechanism is configured to prevent rotational movement of the lockrod relative to the bearing plate. In particular, the first pair of apertures of the bearing plate are able to be aligned with the second pair of apertures of the lockrod, and the fastener is received through the first and second pair of apertures to prevent rotational movement of the lockrod relative to the bearing plate.

In one illustrative embodiment, the fastener may be one of a pad lock, a band seal, and a spike seal.

In another illustrative embodiment, the locking mechanism may also include a bushing between the lockrod and the bearing plate. The first and second pairs of apertures may be positioned above the bushing.

Alternatively, the bushing may include a third pair of horizontally-aligned apertures and the third pair of apertures of the bushing may be able to be aligned with the first and second pairs of apertures.

In still another illustrative embodiment, the locking mechanism may also include (i) a locking cam coupled to an end of the lockrod and adapted to engage a lockrod keeper coupled to the door frame, and (ii) a handle assembly coupled to the locking cam. Illustratively, the handle assembly may be configured to move the locking cam into or out of engagement with the lockrod keeper. Further, the handle assembly and the locking cam may be movable between a locked position wherein the handle assembly is parallel to a plane defined by the door and an unlocked position wherein the handle assembly is angled relative to the plane of the door. The first and second pair of apertures may be aligned with each other when the handle assembly in the locked position.

In yet another illustrative embodiment, the locking mechanism may also include a locking cam coupled to an end of the lockrod and adapted to engage a lockrod keeper coupled to the door frame. Illustratively, the locking cam may be movable between a first position in which the locking cam engages the keeper to maintain the door in the closed position relative to the door frame and a second position in which the locking cam disengages the keeper to allow the door to open. Further, the first and second pair of apertures may be aligned with each other when the locking cam is in the first position.

In still another illustrative embodiment, the locking mechanism may also include a second bearing plate configured to be coupled to a second swing door. A second lockrod may be received within a second channel of the second bearing plate for rotational movement relative thereto. The second bearing plate may include a third pair of horizontally-aligned apertures and the lockrod may include a fourth pair of horizontally-aligned apertures that are configured to be aligned with the third pair of apertures of the lockrod. The fastener may also be received through the third and fourth pair of apertures to prevent rotational movement of the second lockrod relative to the second bearing plate.

According to yet another aspect of the present disclosure, a locking assembly for a door of a storage container includes a main door locking mechanism coupled to the door and an auxiliary door locking mechanism coupled to the door.

In one illustrative embodiment, the main door locking mechanism may include a lockrod configured to be coupled to the door, a locking cam coupled to an end of the lockrod and adapted to engage a lockrod keeper coupled to the door frame, and a handle assembly coupled to the locking cam. The handle assembly may be configured to move the locking cam into or out of engagement with the lockrod keeper when in an unlocked position by rotating the lockrod relative to the lockrod keeper. Further illustratively, the auxiliary door locking mechanism may be configured to prevent rotational movement of the lockrod relative to the door when the handle assembly is in the unlocked position.

Further illustratively, the auxiliary door locking mechanism may include (i) a bearing plate configured to be coupled to the door and including a body defining a longitudinally-extending channel and a first pair of horizontally-aligned apertures formed therethrough, (ii) a second pair of horizontally-aligned apertures formed through the lockrod, wherein the first and second pair of apertures are configured to be aligned with each other, and (iii) a fastener configured to be received through the first and second pair of apertures to prevent rotational movement of the lockrod relative to the bearing plate. The fastener may illustratively be a pad lock, a band seal, and/or a spike seal.

The fastener may be removably received through the first and second pair of apertures.

According to another aspect of the present disclosure, a method of adding an auxiliary locking mechanism to a main locking mechanism for a door of a storage container includes providing a main locking mechanism including a bearing plate coupled to the door of the storage container, a lockrod received through a vertically-extending channel of the bearing plate, a locking cam coupled to a lower end of the lockrod, and a lockrod keeper coupled to the door frame and configured to receive the locking cam therein when the main locking mechanism is in a locked position. The method also includes forming a first pair of horizontally-aligned apertures through the bearing plate and forming a second pair of horizontally-aligned apertures through the lockrod at a location aligned with the first pair of horizontally-aligned apertures of the bearing plate when the main locking mechanism is in the locked position. Finally, the method includes inserting a fastener through the first and second pair of apertures in order to prevent rotational movement of the lockrod relative to the bearing plate when the main locking mechanism is in the locked position.

In one illustrative embodiment, the fastener may be removably received though the first and second pair of apertures.

In another illustrative embodiment, forming a second pair of horizontally-aligned apertures through the lockrod may include forming an aperture through the lockrod that is horizontally-aligned with a pre-existing aperture of the lockrod.

### BRIEF DESCRIPTION OF THE DRAWINGS

FIG. 1 is a rear perspective view of a trailer having a door locking assembly including two main door locking mechanisms and two auxiliary door locking mechanisms for maintaining rear doors of the trailer in a closed position.

FIG. 2 is a rear perspective view of a portion of the trailer of FIG. 1 showing a portion of one of the main door locking mechanisms and showing a plurality of different embodiments of the auxiliary door locking mechanism of the present disclosure.

FIG. 3 is a rear view of a portion of the trailer of FIGS. 1 and 2 showing an alternative auxiliary door locking assembly.

FIG. 4 is an exploded, perspective view of a portion of the main door locking assembly and one of the alternative auxiliary door locking assembly shown in FIG. 2.

FIG. 5 is an exploded, perspective view of a portion of the main door locking assembly and an alternative auxiliary door locking assembly of the present disclosure.

### DETAILED DESCRIPTION OF THE DRAWINGS

For the purposes of promoting an understanding of the principles of the invention, reference will now be made to illustrative embodiments shown in the attached drawings and specific language will be used to describe the same. While the concepts of this disclosure are described in relation to a truck trailer, it will be understood that they are equally applicable to other storage containers generally, and more specifically to transportable containers for transporting one or more objects, examples of which include, but should not be limited to, straight truck bodies, mobile storage containers, small personal and/or commercial trailers and the like. In particular, concepts of this disclosure may be applied to most any door locking mechanism used with the aforementioned storage containers. Accordingly, those skilled in the art will appreciate that the present invention may be implemented in a number of different applications and embodiments and is not specifically limited in its application to the particular embodiments depicted herein.

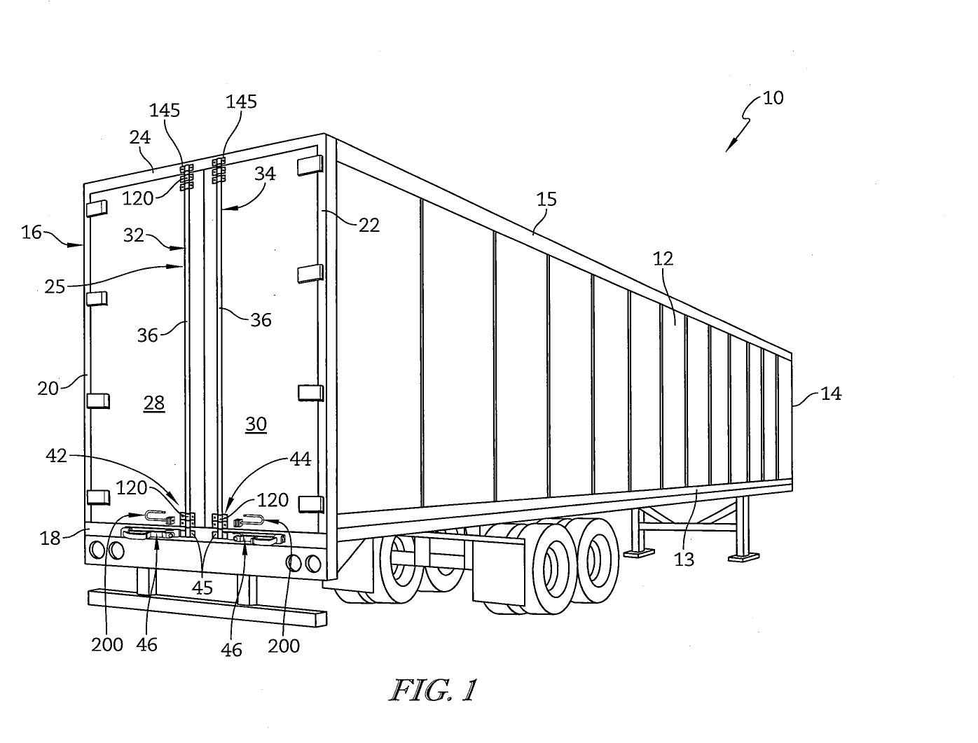

Referring now to FIG. 1, one illustrative embodiment of a conventional trailer 10 is shown. In the illustrated embodiment, the trailer 10 includes a pair of opposing sidewalls 12 that extend the length of the trailer 10 and that are each attached at a front end thereof to a front wall 14. Each sidewall 12 is affixed at a bottom end thereof to a side or base rail 13, and at a top end to a top rail 15. Rear ends of the sidewall 12 are attached to a rear door frame 16 of the trailer 10 that includes a bottom frame member or sill 18, and a pair of side frame members 20 and 22 extending upwardly from opposite ends of the sill 18 and connected at their opposite ends to a top frame member 24.

The trailer 10 includes a locking assembly 25 that is generally mounted to the top frame member 24 and also to the bottom frame member or sill 18. The locking assembly 25 is further configured to be attached to each of the two rear swing doors 28, 30 that are mounted to the side frame members 20 and 22, respectively, in a conventional manner such that the door 28 is hingedly coupled to and swings relative to the side frame member 20 between opened and closed positions, and the other door 30 is hingedly coupled to and swings relative to the side frame member 22 between opened and closed positions.

As shown in FIG. 1, the locking assembly 25 includes a pair of main door locking mechanisms 32 and 34 that are each configured to engage a respective one of the doors 28, 30. In particular, the main door locking mechanism 32 is coupled to the door 28 while the main door locking mechanism 34 is coupled to the door 30. The locking assembly 25 further includes a pair of auxiliary door locking mechanisms 42, 44 associated with each respective main door locking mechanism 32, 34. Accordingly, the auxiliary door locking mechanism 42 is associated with the main door locking mechanism 32 and the auxiliary door locking mechanism 44 is associated with the main door locking mechanism 34. The main and auxiliary door locking mechanisms 32, 34 and 42, 44 are provided to maintain each respective door 28, 30 in a closed position. The use of the auxiliary locking mechanism 42, 44 increases security to the trailer 10 by providing an independent, alternate locking capability.

In the embodiment illustrated in FIG. 1, the door 28 is hingedly mounted to the side frame member 20 and the door 30 is hingedly mounted to the side frame member 22. The opposite free side of each of the doors 28, 30 is configured to engage the free side of the other of each of the doors 28, 30 when the doors 28, 30 are in their closed positions, as shown in FIG. 1. Illustratively, the main and auxiliary door locking mechanisms 32, 34 and 42, 44 are generally positioned adjacent the free side of the respective door 28, 30 to which each is coupled. While FIG. 1 and the embodiments described herein illustrate the main and auxiliary door locking mechanism 32, 34 and 42, 44 for use with a conventional two door trailer 10, it is understood that each of the main and auxiliary door locking mechanism 32, 34 and 42, 44 may be used with a trailer or other storage container in which only one rear door is provided.

For purposes of this document, structural embodiments and operation of only the main door locking mechanism 34 and the auxiliary door locking mechanism 44 will be illustrated and described herein; however, it will be understood that the main door locking mechanism 32 is identical in configuration and operation to the main door locking mechanism 34, and the and the auxiliary door locking mechanism 42 is identical in configuration and operation as the auxiliary door locking mechanism 44. Further, various components and operation of the main door locking mechanism 34 that relate to the auxiliary door locking mechanism 44 will be described herein. Additional detail related to the components and operation of the main door locking assembly 34 can be found in U.S. Pat. No. 8,720,957 (hereinafter, the '957 patent), the entirety of which is hereby incorporated by reference herein.

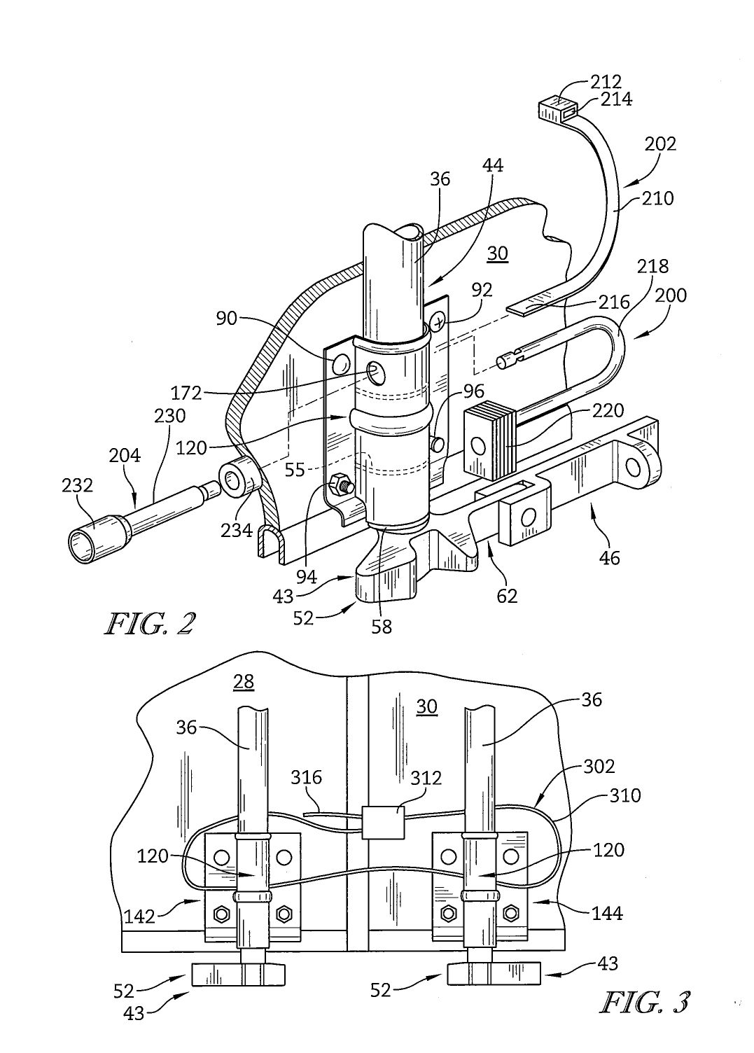

As shown in FIG. 1, the main door locking mechanism 34 includes an elongated lockrod 36 attached at an upper end thereof to an upper locking cam (not shown) that is configured to releasably engage an upper lockrod keeper 145 mounted to the top frame member 24 of the trailer 10. The opposite, or bottom, end of the lockrod 36 is likewise attached to a lower locking cam 43 (shown in FIG. 2, for example) that is configured to releasably engage a lower lockrod keeper 45 mounted to the lower frame member or sill 18 of the trailer 10. The door locking mechanism 34 further includes a handle assembly 46 (a portion of which is shown in FIG. 2) that is operatively connected to the lower locking cam 43. Illustratively, the lockrod 36 of each main door locking mechanism 32, 34 is positioned adjacent the free side of the door 28, 30 to which it is attached and is coupled to the respective door 28, 30 at both the upper and lower ends thereof via bearing plates 120, as discussed in greater detail below.

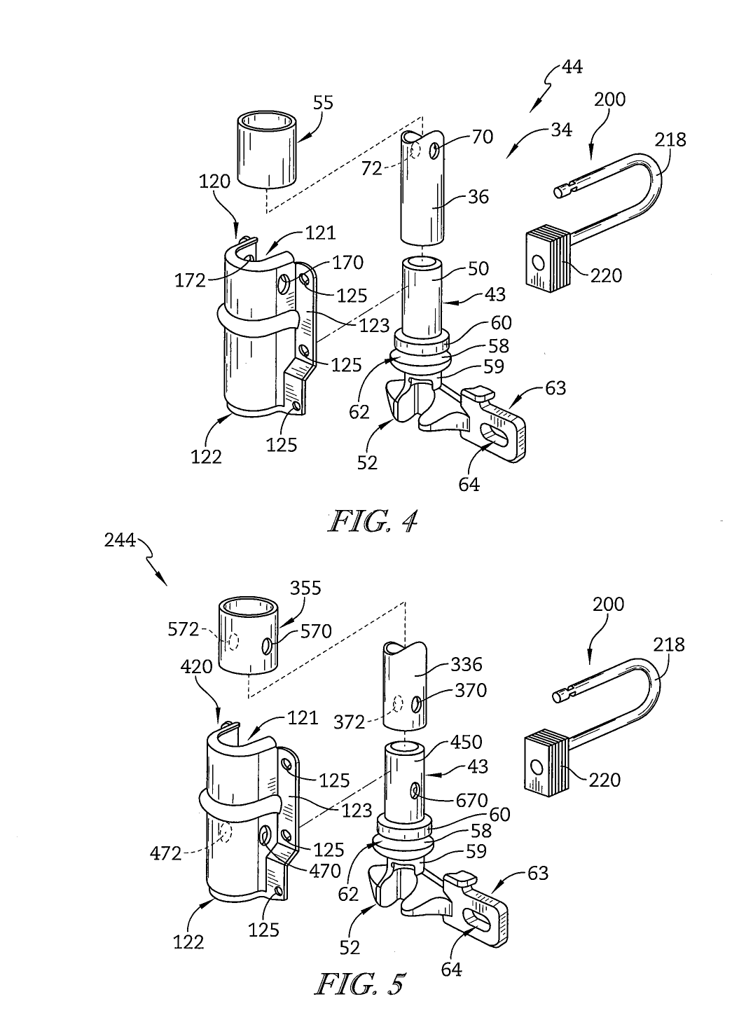

Looking now to FIG. 4, the lower locking cam 43 of the main door locking mechanism 34 includes a stem 50 received within the lower end of the lockrod 36. The stem 50 is coupled to a cam body 52. The cam body 52 extends upwardly to define a neck portion 59 and a first collar 58 that extends about the neck portion 59. The lower locking cam 43 further defines a second collar 60 that is separated from the first collar by a channel 62. The stem 50 of the locking cam 43 extends upwardly from the upper collar 60.

The lower locking cam 43 further includes a protrusion 63 coupled to the cam body 52 and positioned to extend outwardly in a lateral direction therefrom. The protrusion 63 defines a slot 64 formed therein. As is discussed in the '957 patent, the protrusion 63 is coupled to a handle assembly of the main locking mechanism 34, a portion of which is shown at 46 within FIG. 2, in order to allow the handle to move laterally relative the protrusion 63 between first and second positions.

As shown in FIGS. 2 and 4, the main locking mechanism 34 further includes a bearing plate 120 configured to be coupled to the locking cam 43 and the door 30 of the trailer 10. Illustratively, the bearing plate 120 includes a body that defines a longitudinally-extending channel 121 having a generally semi-circular cross-sectional shape configured to receive at least a portion of the lockrod 36 and stem 50 of the locking cam 43 therein. Side flanges 123 of the bearing plate 120 include apertures 125 configured to receive fasteners, such as the rivet 90, screw 92, bolt 94, or pin 96 illustratively shown in FIG. 2, in order to secure the bearing plate 120 to the door 30 of the trailer 10. It should be understood that each aperture 125 may receive any one of the illustrative rivet 90, screw 92, bolt 94, or pin 96 therein as well as any other suitable fastener for securing the bearing plate 120 to the door 30 of the trailer 10. Illustratively, a lower portion 122 of the bearing plate 120 is illustratively rolled to form a bottom surface (not shown) that is received within the channel 62 between the collars 58 and 60 of the locking cam 43 in order to couple the bearing plate 120 to the locking cam 42. This rolled surface further extends at least partially about the locking cam 43 within the channel 62 such that the rolled surface of the bearing plate 120 is captured within the channel 62 between the collars 58, 60 of the locking cam 43. The bearing plate 120 is attached to the door 30 adjacent to the free side and adjacent the bottom of the door 30. The lower, rolled surface of the lower bearing plate 120 being received within the channel 62, axial motion of the lockrod 36 is inhibited while simultaneously allowing rotation of the lockrod 36 relative to the upper and lower bearing plates 120.

The main locking mechanism 34 further includes a bushing 55, as shown in FIG. 4 and in phantom in FIG. 2. The bushing 55 is a sleeve, or hollow cylinder, as shown best in FIG. 4, that fits over the lockrod 36. The bushing 55 is preferably plastic in order to allow the lockrod 36 to rotate freely relative to the bearing plate 120. However, other suitable bearing materials may be used as well.

The lower lockrod keeper 45 of the main door locking mechanism 34 is coupled to the bottom sill 18 of the trailer 10 and is configured to receive the cam body 52 of the lower locking cam 43 therein. The upper lockrod keeper 145 of the main door locking mechanism 34 is coupled to the top frame member 24 of the trailer 10 and is configured to receive a cam body of an upper locking cam therein. In use, the main door locking mechanism 34 is movable between a fully locked position and a fully unlocked position whereby the door 30 is able to be opened relative to the rear trailer frame 16. Once the handle assembly (partially shown at 46) is unlocked from the sill 18 of the trailer 10, the user may rotate the entire handle assembly 46, locking cam 43, and locking rod 36 relative to the upper and lower lockrod keepers 145, 45 about a pivot axis defined by the lockrod 36 to ultimately detach the lower locking cam body 52 from within the lower lockrod keeper 45 and the upper locking cam body from within the upper lockrod keeper 145 to allow the door 30 to be opened. When in the locked position, the handle of the main door locking mechanism 34 extends generally horizontally to define an axis that is parallel to a plane defined by the door 30 and is unable to rotate about an axis defined by the lockrod 36. When the handle of the main door locking mechanism 34 is moved to an unlocked position, the handle is able to be moved such that the axis defined by the handle is angled, and not parallel, to the plane defined by the door 30 in order to rotate the lockrod 36 and detach the upper and lower locking cams from within the respective upper and lower lockrod keepers 145, 45.

As noted above, an auxiliary locking mechanism 44 is provided for use with the main locking mechanism 34. Illustratively, the auxiliary locking mechanism 44 provides the user with an additional means for locking the assembly 25 in order to prevent the door 30 of the trailer 10 from being opened. Components of the auxiliary door locking mechanism 44 are also components of the main door locking mechanism 34. For example, the lockrod 36 is a component of the main locking mechanism 34 and is also a component of the auxiliary locking mechanism 44. In particular, the lockrod 36 includes a pair of apertures 70 and 72 (shown in phantom in FIG. 4) which define a portion of the auxiliary locking mechanism 44. The apertures 70, 72 are horizontally-aligned with each other such that a generally straight pin or fastener may be inserted therethrough. Similarly, the bearing plate 120 is a component of the main locking mechanism 34 and is also a component of the auxiliary locking mechanism 44. In particular, the bearing plate 120 similarly includes a pair of apertures 170, 172 each formed through one end of the generally semi-circular portion of the bearing plate 120 which define a portion of the auxiliary locking mechanism 44. The pair of apertures 70, 72 of the lockrod 36 is configured to be aligned with the pair of apertures 170, 172 of the bearing plate 120 when the main locking mechanism 34 is in a locked position as discussed within the '957 patent, so that the cam body 52 is received within the lockrod keeper 45. Also, the pair of apertures 70, 72 of the lockrod 36 is configured to be aligned with the pair of apertures 170, 172 of the bearing plate 120 when the cam body 52 is not necessarily received within the lockrod keeper 45 but when the handle is rotated to a position when the axis defining the handle is generally parallel to the door 30. Illustratively, the apertures 70, 72 and 170, 172 are positioned at a location generally above a top edge of the bushing 55 of the main locking mechanism 34, as shown best in FIG. 2.

In use, a fastener or conventional locking device such as a padlock 200, a zip tie or band seal 202, or a spike seal 204, for example, may be inserted through the aligned pairs of apertures 70, 72, 170, 172 and secured in order to prevent the lockrod 36 from being pivotably movable relative to the bearing plate 120. Illustratively, the padlock 200 includes a housing 220 and a generally U-shaped lock arm 218 having a first end fixedly coupled to the housing 220 and a second end releasably coupled to the housing 220 as is typical for a padlock. In use, the free end of the lock arm 218 is inserted through the aligned apertures 70, 72, 170, 172 of the lock rod 36 and the bearing plate 120 and then coupled to the housing 220. The free end of the lock arm 218 may be selectively uncoupled from the housing 220 by a user in order to remove the lock arm 218 from within the apertures 70, 72, 170, 172 to unlock the auxiliary locking mechanism 44.

Similar to the lock 200, the zip tie 202 includes an arm to be received within the apertures 70, 72, 170, 172 in order to prevent relative rotational movement between the lock rod 36 and the bearing plate 120. In particular, the illustrative zip tie 202 includes a flexible arm 210 having a free end 216, and a housing 212 coupled to the other end of the flexible arm 210. The housing 212 includes a slot 214 defined therein in order to lockingly receive the free end 216 of the flexible arm 210 therein. In use, the free end 216 of the flexible arm 210 is inserted through the aligned apertures 70, 72, 170, 172 of the lock rod 36 and the bearing plate 120 and then inserted through the slot 214 in order to couple the free end 216 of the arm 210 to the housing 212. The free end 216 of the arm 210 may be selectively uncoupled from the housing 212 by a user in order to remove the flexible arm 210 from within the apertures 70, 72, 170, 172 to unlock the locking mechanism 44.

The illustrative spike seal 204 includes an elongated body 230 sized and configured to be received through the aligned apertures 70, 72, 170, 172 and a head 232 coupled to one end of the body 230. A diameter of the head 232 is larger than that of the apertures 70, 72,170, 172 in order to prevent the head 232 from being received through the apertures 70, 72, 170, 172. A removable seal 234 may be placed over the free end of the body 230 in order to prevent the elongated body 230 from being removed from within the apertures 70, 72, 170, 172. The seal 234 may be selectively removed from the free end of the body 230 by a user in order to remove the elongated body 230 from within the apertures 70, 72, 170, 172 to unlock the auxiliary locking mechanism.

The illustrative fasteners 200, 202, 204 each include an arm, or body, which is received through the apertures 70, 72, 170, 172 from one side of the bearing plate 120 and lockrod 36 to the other in order to prevent relative movement between the lockrod 36 and the bearing plate 120. While the illustrative fasteners 200, 202, 204 are shown in FIG. 2 and described above, it should be understood that any suitable fastener that is able to be received through the apertures 70, 72, 170, 172 and selectively locked in order to prevent the same fastener from being removed from the apertures 70, 72, 170,172 may be used as well. By preventing the lockrod 36 from being able to pivot relative the bearing plate 120, the lockrod 36 cannot be pivoted in such a way as to remove the cam body 52 of the lower locking cam 43 (coupled to a bottom end of the lockrod 36 for movement therewith) from the lower lockrod keeper 45 which holds the locking cam 43 therein when the main locking mechanism 34 is in the locked position. Similarly, the cam body of the upper locking cam (that is coupled to a top end of the lockrod 36 for movement therewith) cannot be removed from the upper lockrod keeper 145. In other words, even if the handle 46 of the main locking mechanism 34 is in an unlocked position, the auxiliary locking mechanism 44 operates to prevent the lower locking cam 43 from being removed from the lower lockrod keeper 45 (and the upper locking cam from the upper lockrod keeper 145), thus preventing the door 30 of the trailer 10 from being able to be opened.

As shown in FIG. 3, alternative locking mechanisms 142, 144 include a single fastener 302 which may be threaded through the apertures 70, 72, 170, 172 of each of the lockrods 36 and bearing plates 120 of the auxiliary locking mechanisms 142, 144 in order to lock each of the auxiliary locking mechanisms 142, 144 simultaneously (i.e., through the use of a single fastener). The illustrative single fastener 302 is similar to the zip tie 202 shown in FIG. 2 and described above, but may also be any suitable fastener such as the lock 200 or pin 204 that is sized and configured to be threaded through the apertures 70, 72, 170, 172 of both lockrods 36 and bearing plates 120 associated with each door 28, 30 in order to lock, or prevent, the rotational movement of each lockrods 36 relative to the respective bearing plate 120 with a single fastener.

While the particular apertures 70, 72, 170, 172 through the lockrod 36 and bearing plate 120, respectively, are illustrated in FIGS. 2 and 4 to be in a location generally above the bushing 55, it should be understood that the apertures 70, 72, 170, 172 may be positioned at other suitable locations. For example, as shown in FIG. 5, an alternative auxiliary locking mechanism 244 is provided whereby the location of the apertures is modified from that which is shown in FIGS. 2 and 4. In particular, a pair of apertures 370, 372 of the lockrod 336 is positioned lower on the lockrod 336 than the pair of apertures 70, 72 of the lockrod 36. Similarly, a pair of apertures 470, 472 of the bearing plate 420 is positioned lower than the corresponding apertures 170, 172 of the bearing plate 120. Accordingly, the bushing 355 shown in FIG. 5 also includes a pair of apertures 570, 572 and the stem 450 of the locking cam 43 similarly includes a channel 670 formed therethrough. In use, the apertures 370, 372 of the lockrod 336, the apertures 470, 472 of the bearing plate 420, the apertures 570, 572 of the bushing 355 and the channel 670 of the stem 450 are all aligned to allow a user to place a fastener, such as the pad lock 200, band seal 202 or spike seal 204, for example, therethrough.

Illustratively, the lockrods 36, 336 described herein each have two, horizontally-aligned apertures 70, 72 and 370, 372 formed therein which operate as part of the auxiliary locking mechanism 44, 244. It should be understood that some lockrods used with existing main locking mechanisms such as the main door locking mechanism 34, for example, already include a single through hole oftentimes provided in order to operate as a drain for any liquid which may enter the inner passageway of the lockrod. Any liquid within the lockrod, such as lockrods 36 and 336, may cause damage to the lockrod if the liquid therein freezes. As such, the use of a drainage hole may operate to prevent freezing damage of the lockrod 36. Further, the use of a through hole within a lockrod may provide a location for the lockrod to be hung on a hook, for example, during a hot dip galvanization process. As such, in a retrofit process, an existing main locking mechanism having a lockrod with a single drainage aperture may be modified to include a second aperture aligned with the first (as well as aligned apertures in the bearing plate) in order to create the auxiliary locking mechanism of the present disclosure.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A locking mechanism for use with a swing door of a storage container, the storage container defining a door frame, the door movably mounted to the door frame, the locking mechanism comprising:
a bearing plate configured to be coupled to the door, wherein the bearing plate includes (i) a body defining a longitudinally-extending channel and (ii) a first pair of horizontally-aligned apertures formed through the body;
a lockrod configured to be received within the channel of the bearing plate for rotational movement relative to the bearing plate, the lockrod including a second pair of horizontally-aligned apertures formed therethrough; and
a fastener configured to prevent rotational movement of the lockrod relative to the bearing plate,
wherein the first pair of apertures of the bearing plate configured to be aligned with the second pair of apertures of the lockrod, and wherein the fastener is received through the first and second pair of aligned apertures to prevent rotational movement of the lockrod relative to the bearing plate.

2. The locking mechanism of claim 1, wherein the fastener is one of a pad lock, a band seal, and a spike seal.

3. The locking mechanism of claim 1, further comprising a bushing between the lockrod and the bearing plate, and wherein the first and second pairs of apertures are positioned above the bushing.

4. The locking mechanism of claim 1, further comprising a bushing between the lockrod and the bearing plate, and wherein the bushing includes a third pair of horizontally-aligned apertures, and the third pair of apertures of the bushing are configured to be aligned with the first and second pairs of apertures.

5. The locking mechanism of claim 1, further comprising (i) a locking cam coupled to an end of the lockrod and adapted to engage a lockrod keeper coupled to the door frame, and (ii) a handle assembly coupled to the locking cam, the handle assembly being configured to move the locking cam into or out of engagement with the lockrod keeper, wherein the handle assembly and the locking cam are movable between a locked position wherein the handle assembly is parallel to a plane defined by the door and an unlocked position wherein the handle assembly is angled relative to the plane of the door, and wherein the first and second pair of apertures are aligned with each other when the handle assembly in the locked position.

6. The locking mechanism of claim 1, further comprising a locking cam coupled to an end of the lockrod and adapted to engage a lockrod keeper coupled to the door frame, wherein the locking cam is movable between a first position in which the locking cam engages the keeper to maintain the door in the closed position relative to the door frame and a second position in which the locking cam disengages the keeper to allow the door to open, and wherein the first and second pair of apertures are aligned with each other when the locking cam is in the first position.

7. The locking mechanism of claim 1, further comprising a second bearing plate configured to be coupled to a second swing door, a second lockrod received within a second channel of the second bearing plate for rotational movement relative thereto, wherein the second bearing plate includes a third pair of horizontally-aligned apertures and the lockrod includes a fourth pair of horizontally-aligned apertures that are configured to be aligned with the third pair of apertures of the lockrod, wherein the fastener is also received through the third and fourth pair of apertures to prevent rotational movement of the second lockrod relative to the second bearing plate.

8. A locking mechanism for use with a swing door of a storage container, the storage container defining a door frame, the door movably mounted to the door frame, the locking mechanism comprising:
a main door locking mechanism coupled to the door; and
an auxiliary door locking mechanism coupled to the door, wherein the auxiliary door locking mechanism is configured to maintain the door in a closed position when the main door locking mechanism is in an unlocked position.

9. The locking mechanism of claim 8, wherein the main door locking mechanism includes a lockrod configured to be coupled to the door, a locking cam coupled to an end of the lockrod and adapted to engage a lockrod keeper coupled to the door frame, and a handle assembly coupled to the locking cam, the handle assembly being configured to move the locking cam into or out of engagement with the lockrod keeper when in an unlocked position by rotating the lockrod relative to the lockrod keeper, and wherein the auxiliary door locking mechanism is configured to prevent rotational movement of the lockrod relative to the door when the handle assembly is in the unlocked position.

10. The locking mechanism of claim 9, wherein the auxiliary door locking mechanism includes (i) a bearing plate configured to be coupled to the door and including a body defining a longitudinally-extending channel and a first pair of horizontally-aligned apertures formed therethrough, (ii) a second pair of horizontally-aligned apertures formed through the lockrod, wherein the first and second pair of apertures are configured to be aligned with each other, and (iii) a fastener configured to be received through the first and second pair of apertures to prevent rotational movement of the lockrod relative to the bearing plate.

11. The locking mechanism of claim 10, wherein the fastener is one of a pad lock, a band seal, and a spike seal.

12. The locking mechanism of claim 10, wherein the fastener is removably received through the first and second pair of apertures.

13. A method of adding an auxiliary locking mechanism to a main locking mechanism for use with a swing door of a storage container, the storage container defining a door frame, the door movably mounted to the door frame, the method including:
providing a main locking mechanism including a bearing plate coupled to the door of the storage container, a lockrod received through a vertically-extending channel of the bearing plate, a locking cam coupled to a lower end of the lockrod, and a lockrod keeper coupled to the door frame and configured to receive the locking cam therein when the main locking mechanism is in a locked position;
forming a first pair of horizontally-aligned apertures through the bearing plate;
forming a second pair of horizontally-aligned apertures through the lockrod at a location aligned with the first pair of horizontally-aligned apertures of the bearing plate when the main locking mechanism is in its locked position; and
inserting a fastener through the first and second pair of apertures in order to prevent rotational movement of the lockrod relative to the bearing plate when the main locking mechanism is in its locked and unlocked position.

14. The method of claim 13, wherein the fastener is removably received though the first and second pair of apertures.

15. The method of claim 13, wherein forming a second pair of horizontally-aligned apertures through the lockrod includes forming an aperture through the lockrod that is horizontally-aligned with a pre-existing aperture of the lockrod.
